(19) United States
(12) Patent Application Publication
(10) Pub. No.: US 2020/0282568 A1
(43) Pub. Date: Sep. 10, 2020

(54) ROBOT CONTROL DEVICE AND ROBOT SYSTEM

(71) Applicant: KAWASAKI JUKOGYO KABUSHIKI KAISHA, Kobe-shi (JP)

(72) Inventors: Masataka TANABE, Kakogawa-shi (JP); Atsushi KAMEYAMA, Kakogawa-shi (JP); Takahiro KIKUCHI, Kakogawa-shi (JP); Hiroaki YASUMOTO, Kobe-shi (JP)

(73) Assignee: KAWASAKI JUKOGYO KABUSHIKI KAISHA, Kobe-shi (JP)

(21) Appl. No.: 16/884,058

(22) Filed: May 27, 2020

Related U.S. Application Data
(63) Continuation of application No. PCT/JP2018/042520, filed on Nov. 16, 2018.

(30) Foreign Application Priority Data
Nov. 27, 2017 (JP) 2017-227113

(51) Int. Cl. B25J 13/06

(52) U.S. Cl. CPC B25J 13/06

(57) ABSTRACT

The present application relates a robot control device for controlling a robot and a robot system. The robot control device controls the robot selectively in a normal operating mode and in an overdrive mode. In the normal operating mode, the robot control device controls the robot to operate within an allowable range according to load applied to the robot. In the overdrive mode, the robot control device controls the robot to operate at high speed without operation of the robot being limited to the allowable range. To control the robot in the over drive mode, the robot control device interlockingly changes magnification scales, of a plurality of parameters that specify an operating speed of the robot, based on an overdrive magnification scale about a degree of a high speed operation of the robot in the overdrive mode.

### CROSS-REFERENCE TO RELATED APPLICATIONS

The present application is a bypass continuation of PCT Application No. PCT/JP2018/042520, filed Nov. 16, 2018, which claims priority to JP 2017-227113, filed Nov. 27, 2017, both of which are incorporated by reference in their entirety.

### TECHNICAL FIELD

The present application relates to a robot control device and a robot system.

### BACKGROUND ART

Conventionally, robot control devices which control a robot aim to demonstrate a capability of a motor to its maximum extent, no matter what point an acceleration start point and a deceleration end point of the robot may be. The robot control device may do this to shorten an operating time. Moreover, when a teaching point memory means receives a move command, the robot control device analyzes the move command and determines from which point to which point the robot is to be moved.

However, such conventional robot control devices operate the robot within an allowable range that is predefined according to a load to be applied to the robot. Therefore, a tact time cannot be fully shortened.

### SUMMARY

In order to solve the above-described problem, a robot control device according to one aspect of the present application configured to control a robot is provided. The robot control device controls the robot selectively in a normal operating mode in which the robot is operated within an allowable range defined beforehand according to load applied to the robot and an overdrive mode in which the robot is operated at high speed without operation of the robot being limited to the allowable range. The robot control device operates the robot at high speed in the overdrive mode by interlockingly changing magnification scales of a plurality of parameters defined beforehand that may specify an operating speed of the robot, based on an overdrive magnification scale defined beforehand about a degree of the high-speed operation in the overdrive mode.

In order to solve the described problem, a robot system according to another aspect of the present application is provided. The robot system includes a robot control device and a robot controlled by the robot control device.

### BRIEF DESCRIPTION OF DRAWINGS

FIG. 1 is a schematic view illustrating a configuration of a robot system according to an embodiment of the present application.

FIG. 2 is a flowchart of a method of operating a robot at high speed executed by the robot system according to an embodiment of the present application.

FIG. 3 is a view illustrating an exemplary program process executed by the robot system according to an embodiment of the present application.

### DETAILED DESCRIPTION OF THE DRAWINGS

Hereinafter, a robot control device and a robot system having the robot control device according to one embodiment of the present application is described with reference to the drawings. Note that the present application is not limited to this embodiment. Moreover, below, throughout the figures, the same reference characters are given to the same or corresponding elements to omit redundant description.

(Robot System 10)

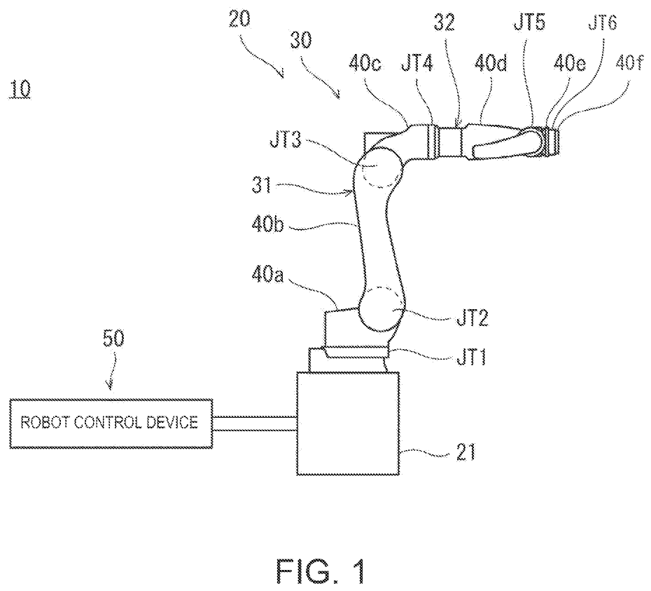

FIG. 1 is a schematic view illustrating a configuration of a robot system according to an embodiment of the present application. As illustrated in FIG. 1, a robot system 10 according to this embodiment includes a robot 20 and a robot control device 50 which controls the robot 20.

(Robot 20)

The robot 20 includes a pedestal 21, a robotic arm 30 of which a base-end part is coupled to the pedestal 21, an end effector which is attached to a tip-end part of the robotic arm 30, and the robot control device 50.

(Robotic Arm 30)

As illustrated in FIG. 1, the robotic arm 30 is an articulated arm having six joints JT1-JT6, and six links 40a-40f The six links 40a-40f are serially coupled to each other through joints JT1-JT6.

A first arm part 31 is comprised of a coupling body of links and joints. In particular, the coupling body of first arm part 31 includes a first joint JT1, a first link 40a, a second joint JT2, a second link 40b, a third joint JT3, and a third link 40c. In detail, the first joint JT1 couples the pedestal 21 to a base-end part of the first link 40a rotatably about an axis extending in the vertical direction. The second joint JT2 couples a tip-end part of the first link 40a to a base-end part of the second link 40b rotatably about an axis extending in the horizontal direction. The third joint JT3 couples a tip-end part of the second link 40b to a base-end part of the third link 40c rotatably about an axis extending in the horizontal direction.

A second arm part 32 is comprised of a coupling body of links and joints. In particular, the coupling body of second arm part 32 includes a fourth joint JT4, a fourth link 40d, a fifth joint JT5, a fifth link 40e, a sixth joint JT6, and a sixth link 40f. In detail, the fourth joint JT4 couples a tip-end part of the third link 40c to a base-end part of the fourth link 40d rotatably about an axis extending in the longitudinal direction of the third link 40c. The fifth joint JT5 couples a tip-end part of the fourth link 40d to a base-end part of the fifth link 40e rotatably about an axis extending in a direction perpendicular to the longitudinal direction of the fourth link 40d. The sixth joint JT6 rotatably couples a tip-end part of the fifth link 40e to a base-end part of the sixth link 40f in a twisted fashion. The end effector is attached to a tip-end part of the sixth link 40f.

(Robot Control Device 50)

Robot control device 50 as disclosed herein may comprise circuitry or processing circuitry which includes general purpose processors, special purpose processors, integrated circuits, ASICs (“Application Specific Integrated Circuits”), conventional circuitry, controllers, and/or combinations thereof which are configured or programmed to perform the disclosed functionality. Processors and controllers are considered processing circuitry or circuitry as they include transistors and other circuitry therein. In this disclosure, any circuitry, units, controllers, or means are hardware carry out or are programmed to perform the recited functionality. The hardware may be any hardware disclosed herein or otherwise known which is programmed or configured to carry out the recited functionality. When the hardware is a processor or controller which may be considered a type of circuitry, the circuitry, means, or units are a combination of hardware and software, the software being used to configure the hardware and/or processor.

The robot control device 50 may operate according to a process stored in a memory etc.

The robot control device 50 controls the robot 20, while switching a mode between a normal operating mode, in which the robot 20 is operated within an allowable range defined beforehand according to a load applied to the robot 20, and an overdrive mode in which the robot 20 is operated at high speed without the operation being limited within the allowable range.

Here, in the robot, an allowable range of a current value is defined beforehand for every joint of the robotic arm while considering a certain safety factor so that the current value does not reach a saturation current, regardless of the operation pattern of the robot. Therefore, for example, the “allowable range defined beforehand according to the load applied to the robot 20” described above means the allowable range of the current value.

The robot control device 50 causes the robot 20 to operate at a high speed in the overdrive mode by interlockingly changing magnification scales of a plurality of parameters defined beforehand which may specify an operating speed of the robot 20, based on an overdrive magnification scale defined beforehand about a degree of the high-speed operation in the overdrive mode.

Here, the plurality of parameters which may specify the operating speed of the robot 20 may include at least any one of an acceleration/deceleration preset value related to the operation of the robot 20, a limit value of electric current supplied to the robot 20, and a cutoff frequency of a low-pass filter which is applied to a positional instruction to the robot 20. The plurality of parameters may be set for every joint of the robotic arm 30.

The overdrive magnification scale may arbitrarily be set within a given range, or a plurality of overdrive magnification scales may be defined beforehand differently in a stepped fashion and one may be selected from the magnification scales. As the overdrive magnification scale increases, it is possible to set the acceleration/deceleration preset value related to the operation of the robot 20, the limit value of the current supplied to the robot 20, and the cutoff frequency of the low-pass filter which is applied to the positional instruction to the robot 20 larger. That is, there is a positive correlation between the overdrive magnification scale, and the acceleration/deceleration preset value related to the operation of the robot 20, the limit value of the current supplied to the robot 20, and the cutoff frequency of the low-pass filter which is applied to the positional instruction to the robot 20.

(Notification of Influence on a Life of the Robot)

The robot control device 50 may provide a notification, of information about an influence on the life of the robot 20, when operating the robot 20 at high speed in the overdrive mode. The mode of the notification is not limited in particular, and, for example, the robot control device 50 may provide such a notification by controlling an output of characters or an image on a display unit, or an output of audio from a speaker. Alternatively, the robot control device 50 may provide the notification by controlling an output light from a light source, such as a light emitting diode (LED).

(How to Operate Robot at High Speed)

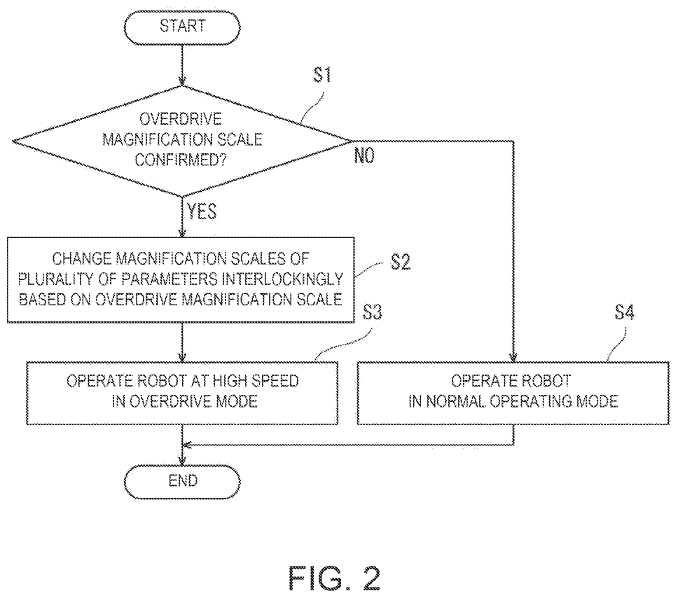

Below, one example of a method of operating the robot at high speed, which is executed by the robot system described above is described mainly based on FIG. 2. FIG. 2 is a flowchart of a method of operating the robot at high speed, executed by the robot system according to the present application.

First, the robot control device 50 confirms an input of an overdrive magnification scale (Step S1). If the robot control device 50 confirms the input of the overdrive magnification scale (“YES” at Step S1), the robot control device 50 then changes the magnification scales of the plurality of parameters interlockingly based on the confirmed overdrive magnification scale (Step S2). Here, as described above, the plurality of parameters are parameters which may specify the operating speed of the robot 20, and, for example, they are the acceleration/deceleration preset value related to the operation of the robot 20, the limit value of the current supplied to the robot 20, and the cutoff frequency of the low-pass filter which is applied to the positional instruction to the robot 20.

Next, the robot control device 50 operates the robot 20 at high speed in the overdrive mode based on the plurality of interlockingly changed parameters (Step S3). As described above, in the robot system 10 according to this embodiment, the robot 20 may be operated at high speed.

In a case that the robot control device 50 does not confirm the input of the overdrive magnification scale (“NO” at Step S1), the robot control device 50 then operates the robot 20 in a normal operating mode (Step S4).

(Example of Program Process)

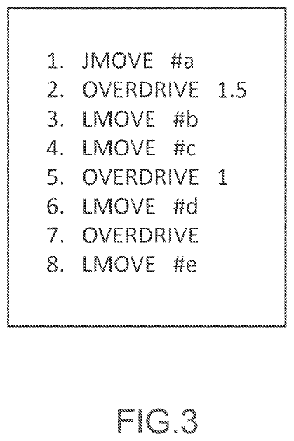

FIG. 3 is a view illustrating an exemplary program process executed by a robot system according to the present application.

In this example, a range within which the overdrive magnification scale may be set is 1.00 or more and 2.00 or less. Note that a settable range of the overdrive magnification scale is not limited to this example. That is, the settable range of the overdrive magnification scale may have lower and higher limits higher than 1.00 and smaller than 2.00, or higher than 2.00. Moreover, the lower limit and the higher limit may be values of the first place of decimals, or may be of the third or more place of decimals, or may be an integer of 1 or larger. Further, as described above, without limiting the plurality of overdrive magnification scales being defined beforehand in the stepped fashion and one being set from the magnification scales, the overdrive magnification scale may arbitrarily be set within a given range.

In this example, the overdrive magnification scale is set as 1.2 in advance by an auxiliary function or a monitor instruction which may set an entire operation of the robot 20. Thus, by setting the overdrive magnification scale, as described above, the robot control device 50 interlockingly changes the magnification scales of the plurality of parameters defined beforehand, which may specify the operating speed of the robot 20 (e.g., the acceleration/deceleration preset value related to the operation of the robot 20, the limit value of the current supplied to the robot 20, and the cutoff frequency of the low-pass filter which is applied to the positional instruction to the robot 20) based on the overdrive magnification scale. Thus, the robot control device 50 operates the robot 20 at high speed in the overdrive mode. In detail, the operation is as follows.

First, the robot control device 50 operates a tip-end part of the robotic arm 30 at high speed based on a command of “1. JMOVE #a” with the overdrive magnification scale of 1.2 to a teaching point #a by using an interpolation of each axis. Here, the each axis interpolation refers to an operation of each joint of the robotic arm 30 by a specified angle, and therefore, does not take an orbit of the tip-end part of the robotic arm 30 into consideration.

Next, the robot control device 50 changes the overdrive magnification scale to 1.5 from 1.2 based on a command of “2. OVERDRIVE 1.5”. The robot control device 50 interlockingly changes the magnification scales of the plurality of parameters defined beforehand which may specify the operating speed of the robot 20, based on the overdrive magnification scale of 1.5. Here, since the overdrive magnification scale is changed to 1.5 from 1.2, the magnification scales of the plurality of parameters are interlockingly changed so that the robot 20 may be operated at a higher speed than before the change.

Moreover, the robot control device 50 operates the tip-end part of the robotic arm 30 at high speed with the overdrive magnification scale of 1.5 to a teaching point #b by a straight line interpolation based on a command of “3. LMOVE #b”. Here, the straight line interpolation refers to a straight movement of the tip-end part of the robotic arm 30 by collaborating the joints of the robotic arm 30.

Further, the robot control device 50 operates the tip-end part of the robotic arm 30 at high speed with the overdrive magnification scale of 1.5 to a teaching point #c by the straight line interpolation based on a command of “4. LMOVE #c”.

Next, the robot control device 50 changes the overdrive magnification scale to 1 from 1.5 based on a command of “5. OVERDRIVE 1”. That is, the robot control device 50 changes the robot 20 from overdrive mode to the normal operating mode based on the command.

Moreover, the robot control device 50 operates the tip-end part of the robotic arm 30 in the normal operating mode to a teaching point #d by the straight line interpolation based on a command of “6. LMOVE #d”.

Further, the robot control device 50 changes the overdrive magnification scale from 1 to 1.2 set in advance by the auxiliary function or the monitor instruction, based on a command of “7. OVERDRIVE”.

Finally, the robot control device 50 operates the tip-end part of the robotic arm 30 at high speed with the overdrive magnification scale of 1.2 to a teaching point #e by the straight line interpolation based on a command of “8. LMOVE #e”.

As described above, the robot control device 50 may control the robot 20 based on the program process illustrated in FIG. 3.

As described above, since the overdrive magnification scale is changed for every work performed by the robot 20, the robot 20 may be controlled efficiently, for example, by setting the overdrive magnification scale smaller when holding a workpiece, and setting the overdrive magnification scale larger when not holding the workpiece. Similarly, the robot 20 may be controlled efficiently by setting the overdrive magnification scale larger when the robotic arm 30 is folded and a distance between its tip-end part and its base-end part is closer (i.e., when the inertia is smaller), and setting the overdrive magnification scale smaller when the robotic arm 30 is extended and the distance between the tip-end part and the base-end part is larger (i.e., when the inertia is larger).

### Effects

The conventional robot control device operates a robot within an allowable range defined beforehand according to the load applied to the robot. For example, the allowable range of a current value is defined beforehand for every joint of a robotic arm while considering a certain safety factor so that the current value does not reach a saturation current, regardless of the operation pattern of the robot. However, depending on an actual work situation, the allowable range may not be appropriate, and therefore, there are cases where it does not cause any problem even if the robot is operated at high speed without the operation being limited to the allowable range. Moreover, there are demands of operating the robot at high speed without the operation being limited to the allowable range, even if the certain safety factor is reduced to sacrifice the life of the robot to some extent.

In order to solve such a problem, the robot control device 50 according to this application controls the robot 20 in the overdrive mode in which the robot 20 is operated at high speed without the operation being limited to the allowable range, in addition to the normal operating mode in which the robot 20 is operated within the allowable range defined beforehand according to the load applied to the robot 20.

In detail, the robot control device 50 according to this application operates the robot 20 at high speed in the overdrive mode by interlockingly changing the magnification scales of a plurality of parameters defined beforehand which may specify the operating speed of the robot 20 based on the overdrive magnification scale defined beforehand about the degree of high-speed operation in the overdrive mode. As a result, the robot control device 50 according to this application fully shortens the tact time by operating the robot 20, without the operation being limited to the allowable range defined beforehand according to the load applied to the robot 20. Additionally, the robot control device 50 may fully shorten the tact time by operating the robot 20 at high speed, without the operation being limited to the allowable range defined beforehand according to the load applied to the robot.

The plurality of parameters may include at least any one of an acceleration/deceleration preset value according to operation of the robot, a limit value of electric current supplied to the robot, and a cutoff frequency of a low-pass filter that is applied to a positional instruction to the robot.

Moreover, since the overdrive magnification scale may arbitrarily be set within the given range. The plurality of overdrive magnification scales may be defined beforehand differently in the stepped fashion. One overdrive magnification scale may be selected from the plurality of magnification scales and set as the overdrive magnification scale. Additionally, the degree of high-speed operation may be changed according to the work situation of the robot 20. Therefore, devices in accordance with the present application may flexibly address the demand of a user. With these configurations, the overdrive magnification scale may be changed according to a work situation of the robot.

Further, since the robot control device 50 notifies the information on the influence to the life of the robot 20, when operating the robot 20 at high speed in the overdrive mode, it becomes possible to operate the robot 20 at high speed, without the operation being limited to the allowable range defined beforehand according to the load applied to the robot 20, while grasping the influence to the life of the robot 20.

It is apparent for a person skilled in the art that many improvements and other embodiments of the present application are possible from the above description. Therefore, the above description is to be interpreted only as illustration, and it is provided in order to teach a person skilled in the art the best mode to implement the present application. The details of the structures and/or the functions may be changed substantially, without departing from the spirit of the present application.

### DESCRIPTION OF REFERENCE CHARACTERS

10 Robot System
20 Robot
21 Pedestal
30 Robotic Arm
31 First Arm Part
32 Second Arm Part
40a First Link
40b Second Link
40c Third Link
40d Fourth Link
40e Fifth Link
40f Sixth Link
50 Robot Control Device
JT1 First Joint
JT2 Second Joint
JT3 Third Joint
JT4 Fourth Joint
JT5 Fifth Joint
JT6 Sixth Joint

1. A robot control device, comprising:
processing circuitry configured to control a robot selectively in a normal operating mode and an overdrive mode, wherein
in the normal operating mode, the processing circuitry controls the robot to operate within an allowable range according to a load applied to the robot,
in the overdrive mode, the processing circuitry controls the robot to operate at a high speed without being limited to the allowable range, and
to control the robot in the overdrive mode, the processing circuitry interlockingly changes magnification scales, of a plurality of parameters that specify an operating speed of the robot, based on an overdrive magnification scale about a degree of a high speed operation of the robot in the overdrive mode.

2. The robot control device of claim 1, wherein the overdrive magnification scale is set within a given range.

3. The robot control device of claim 1, wherein
the overdrive magnification scale includes a plurality of overdrive magnification scales preset in a stepped fashion, and
one overdrive magnification scale of the plurality of overdrive magnification scales is set as the overdrive magnification scale.

4. The robot control device of claim 1, wherein the plurality of parameters include any one of an acceleration/deceleration preset value according to operation of the robot, a limit value of electric current supplied to the robot, and a cutoff frequency of a low-pass filter that is applied to a positional instruction to the robot.

5. The robot control device of claim 1, wherein in a case that the processing circuitry controls the robot at the high speed in the overdrive mode, the processing circuitry is further configured to provide a notification of information about an influence a life of the robot.

6. The robot control device of claim 1, wherein the allowable range is defined prior to the processing circuitry controlling the robot.

7. The robot control device of claim 1, wherein the plurality of parameters are defined prior to the processing circuitry controlling the robot.

8. The robot control device of claim 1, wherein overdrive magnification scale is defined prior to the processing circuitry controlling the robot.

9. The robot control device of claim 5, wherein the processing circuitry provides the notification by controlling an output of the information via a display.

10. The robot control device of claim 5, wherein the processing circuitry provides the notification by controlling an output of the information via an audio speaker.

11. The robot control device of claim 5, wherein the processing circuitry provides the notification by controlling an output of light from a light source.

12. The robot control device of claim 1, wherein the processing circuitry is further configured to
confirm an input of the overdrive magnification scale;
interlockingly change the magnification scales of the plurality of parameters in a case that the input overdrive magnification scale is confirmed; and
control the robot in the normal operating mode in a case that the input overdrive magnification scale is not confirmed.

13. A robot system, comprising:
a robot; and
a robot control device, the robot control device including processing circuitry configured to control the robot selectively in a normal operating mode and an overdrive mode, wherein
in the normal operating mode, the processing circuitry controls the robot to operate within an allowable range according to a load applied to the robot,
in the overdrive mode, the processing circuitry controls the robot to operate at a high speed without being limited to the allowable range, and
to control the robot in the overdrive mode, the processing circuitry interlockingly changes magnification scales, of a plurality of parameters that specify an operating speed of the robot, based on an overdrive magnification scale about a degree of a high speed operation of the robot in the overdrive mode.

14. The robot system of claim 14, wherein the processing circuitry is further configured to
confirm an input of the overdrive magnification scale;
interlockingly change the magnification scales of the plurality of parameters in a case that the input overdrive magnification scale is confirmed; and
control the robot in the normal operating mode in a case that the input overdrive magnification scale is not confirmed.

15. The robot system of claim 14, wherein the overdrive magnification scale is set within a given range.

16. The robot system of claim 14, wherein
the overdrive magnification scale includes a plurality of overdrive magnification scales preset in a stepped fashion, and
one overdrive magnification scale of the plurality of overdrive magnification scales is set as the overdrive magnification scale.

17. The robot system of claim 14, wherein the plurality of parameters include any one of an acceleration/deceleration preset value according to operation of the robot, a limit value of electric current supplied to the robot, and a cutoff frequency of a low-pass filter that is applied to a positional instruction to the robot.

18. The robot system of claim 14, wherein in a case that the processing circuitry controls the robot at the high speed in the overdrive mode, the processing circuitry is further configured to provide a notification of information about an influence on a life of the robot.

19. A robot control method, comprising:
selectively controlling a robot in a normal operating mode and in an overdrive operating mode;
in the normal operating mode, controlling the robot to operate within an allowable range according to a load applied to the robot; and
in the overdrive mode, controlling the robot to operate at a high speed without being limited to the allowable range, wherein
controlling the robot in the overdrive mode includes interlockingly changing magnification scales, of a plurality of parameters that specify an operating speed of the robot, based on an overdrive magnification scale about a degree of a high speed operation of the robot in the overdrive mode.

20. The robot control method of claim 19, further comprising:
confirming an input of the overdrive magnification scale, wherein
the interlockingly changing the magnification scales of the plurality of parameters is performed in a case that the input overdrive magnification scale is confirmed, and
the controlling the robot in the normal operating mode is performed in a case that the input overdrive magnification scale is not confirmed.
